(19) United States
(12) Patent Application Publication
(10) Pub. No.: US 2007/0060693 A1
(43) Pub. Date: Mar. 15, 2007

(54) Paint composition and method for manufacturing the same

(75) Inventor: Chi-Chuang Ho, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/398,025

(22) Filed: Apr. 4, 2006

(30) Foreign Application Priority Data
Sep. 9, 2005 (TW) 094131029

(51) Int. Cl. C08K 3/22

(52) U.S. Cl. 524/431; 524/493

(57) ABSTRACT

The present invention relates to a paint composition including a polymer. The polymer includes a polymeric resin unit, a silica complex unit, an organic silane coupling agent interconnecting the polymeric resin unit and the silica complex unit, and a plurality of titanium dioxide particles with the silica complex unit of the polymer being absorbingly attached to exterior surfaces thereof. The present invention also provides a method for manufacturing the paint composition. The coating using the paint composition has good transparency and hardness.

### BACKGROUND OF THE INVENTION

1. Technical Field

The present invention generally relates to a paint composition for a coating with good transparency and hardness. The present invention also relates to a method for manufacturing the paint composition.

2. Description of Related Art

Paint is widely used for vehicle, furniture and electrical appliances. It is thus necessary for paint to have good hardness, smoothness and transparency whilst also having attractive colors and appearance.

Conventionally, paint is composed of a resin matrix and an amount of pigment particles blended therein. The pigment particles are generally inorganic particles such as carbon black. However, the physical and chemical properties of inorganic pigment particles are quite different from that of the resin matrix, therefore, both dissolution and dispersion of inorganic pigment particles in the resin matrix are unsatisfactory. Thus, a surface having the paint coated thereon may be rough, and appearance of the surface unsatisfactory. In addition, because the inorganic pigment particles are simply mixed with the resin matrix, physical force therebetween is very weak. Therefore, the inorganic pigment particles are often eroded out of the surface of product, thus creating cavities, which will affect the mechanical properties and appearance of the coating.

Furthermore, because the transparency of pigment particles and the resin matrix is lowered, coating made of paint containing pigment particles and the resin matrix also has poor transparency and appearance.

What is needed, therefore, is a paint composition for a coating with good transparence and hardness and a method of manufacturing the same.

### SUMMARY

One embodiment of the invention provides a paint composition including a polymer. The polymer includes a polymeric resin unit, a silica complex unit, an organic silane coupling agent interconnecting the polymeric resin unit and the silica complex unit, and a plurality of titanium dioxide particles with the silica complex unit of the polymer being absorbingly attached to exterior surfaces thereof

Another embodiment of the invention provides a method for manufacturing the paint composition. The method includes steps of: preparing a plurality of titanium dioxide particles with a silica complex being absorbingly attached to exterior surfaces thereof; conducting a reaction between the silica complex and an organic silane coupling agent thereby creating a sol; and polymerizing the sol with a polymer resin thereby obtaining the paint composition.

### DETAILED DESCRIPTION OF THE PREFERRED EMBODIMENT

A paint composition in accordance with a preferred embodiment includes a polymer. The polymer includes a polymeric resin unit (PRU), a silica complex unit (SCU), an organic silane coupling agent (OSCA) interconnecting the polymeric unit and the silica complex unit, and a plurality of titanium dioxide particles with the silica complex unit of the polymer being absorbingly attached to exterior surfaces thereof. The polymer has a formula as below:

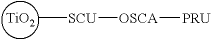

The polymeric resin unit is a matrix material of paint. The polymeric resin unit can be selected from a group consisting of polymethylmethacrylate (PMMA), epoxy, polyurethane, and a copolymer of polyurethane and epoxy.

It is recognized that titanium dioxide is a good photocatalyst. When titanium dioxide is used as inorganic filler in paint, to prevent photocatalysis of the titanium dioxide, a coating can be used, for example a silica complex coated on the titanium dioxide. The silica complex such as colloidal silica coated on titanium dioxide particles can restrain photocatalysis of titanium dioxide effectively.

Colloidal silica has properties of high specific surface area and strong absorbability, and can form thin transparent films. Colloidal silica is sometimes referred to as a ludox or silica sol which has a formula mSiO₂.nH₂O₂. Colloidal silica is a colloidal solution with a faint opaque blue color. Generally, discrete uniform spheres of silica are dispersed in an alkaline medium to form the colloidal solution. The alkaline medium reacts with silica to produce a hydroxyl group with negative charge. Because of this negative charge, particles of silica repel each other thus resulting in stable products. Therefore, colloidal silica has many hydroxyl groups with negative charge on the surface, and siloxane bonds (Si—O—Si) resulting in coalescence and interbonding. A structural formula of colloidal silica is:

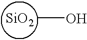

The silica complex for example colloidal silica attaches to exterior surfaces of titanium dioxide particle, which has a structural formula as below:

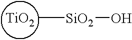

Titanium dioxide has a particle size of in a range from 200 nanometers to 300 nanometers.

The organic silane coupling agent is silane having the ability to bond inorganic substances to organic substances. The organic silane coupling agent molecule contains an organic functional group and a hydrolyzable group. The organic functional group can react with the organic substance while the hydrolyzable group can be bonded to the inorganic substance to achieve a “coupling” effect. A general formula of the organic silane coupling agent is shown below:

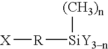

Wherein, n is an integer in a range from 0 to 2, X represents the organic functional group, Y represents the hydrolyzable group such as alkoxy group, and R represents an alkene group. The organic functional group X can bond with Si via the alkene group R. The organic functional group X can be selected from a group consisting of vinyl, epoxy, amino, methacrylic and mercapto. The alkoxy group can be methoxy, ethoxy and so on. The hydrolyzable group Y can be hydrolyzed to produce silanol that will further form a siloxane bond (Si—O—Si) by dehydrolysis.

The organic silane coupling agent can be, for example, 3-(trimethoxysilyl)propyl methacrylate (MSMA), which satisfies a structural formula as below:

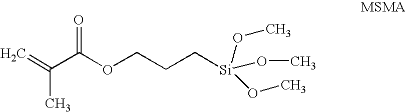

In the preferred embodiment of the present invention, the polymeric resin unit is formed by polymethylmethacrylate, the silica complex unit is formed by colloidal silica, and the organic silane coupling agent is 3-(trimethoxysilyl)propyl methacrylate. In the meantime, the silica complex unit coats the titanium dioxide particles and is attached to exterior surfaces thereof The organic silane coupling agent interconnects the polymeric resin unit and the silica complex unit by “coupling” effect. Thus, a structural formula of the polymer is as below: 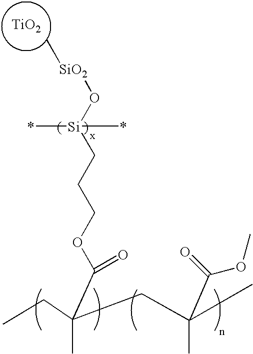
wherein, x is an integer in a range from 50 to 100, n is an integer in a range from 50 to 100.

In the preferred embodiment of the present invention, during the process of coupling, 3-(trimethoxysilyl)propyl methacrylate is at first hydrolyzed to produce silanol, which forms siloxane bond with the inorganic substance such as the silica complex on the exterior surfaces of titanium dioxide particles on one side. On the other side, the organic functional group reacts with the organic substance such as polymethylmethacrylate to produce a chemical bond. As a result, the silica complex unit on the exterior surfaces of titanium dioxide particles and the polymeric resin unit are tightly bound to each other. Titanium dioxide particles serve as pigment and provide color and luster.

A method for manufacturing the paint composition according to the preferred embodiment includes steps in no particular order of:
step 1: preparing a plurality of titanium dioxide particles with a silica complex being absorbingly attached to exterior surfaces thereof;
step 2: conducting a reaction between the silica complex and an organic silane coupling agent thereby creating a sol;
step 3: polymerizing the sol with a polymeric resin thereby obtaining the paint composition.

The following embodiment is provided to describe the method for manufacturing the paint composition in detail. The method includes the following three steps.

Step 1: preparing a plurality of titanium dioxide particles with a silica complex being absorbingly attached to exterior surfaces thereof that represented by SiO₂/TiO₂.

An example for preparing the SiO₂/TiO₂ includes the steps of:
immersing a plurality of titanium dioxide particles in a solution containing tetraethyl orthosilicate (TEOS);
removing an excessive solution of tetraethyl orthosilicate thereby obtaining the wet titanium dioxide particles with the tetraethyl orthosilicate being coated on exterior surfaces thereof;
drying the titanium dioxide particles in vacuum thereby forming the dry titanium dioxide particles coated with tetraethyl orthosilicate; and
conducting a catalyzed reaction of the tetraethyl orthosilicate and alcohol, thereby obtaining the titanium dioxide particles with the silica complex being absorbingly attached to exterior surfaces thereof.

Si(OC₂H₅)₄ represents tetraethyl orthosilicate, and (Si(OC₂H₅)₄/TiO₂) represents the titanium dioxide particles coated with tetraethyl orthosilicate. The titanium dioxide particles coated with the silica complex with different particle size are obtained by base-catalyzed reaction or acid-catalyzed reaction of the titanium dioxide particles coated with tetraethyl orthosilicate. For example, the following is base-catalyzed reaction equation of tetraethyl orthosilicate. The tetraethyl orthosilicate undergoes a base-catalyzed reaction with alcohol in the presence of ammonia to produce the silica complex such as colloidal silica. Therefore, the reactive product is titanium dioxide particles coated with the silica complex.

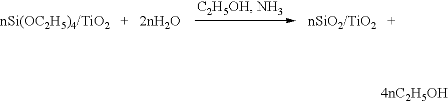

In the preferred embodiment of the present invention, a particle size of titanium dioxide is in a range from 200 nanometers to 300 nanometers. A total particle size of the titanium dioxide and respective silica complex is in a range from 200 nanometers to 500 nanometers. The segment of titanium dioxide particles coated with the silica complex unit of the polymer is represented by a structural formula as below:

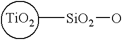

Step 2: conducting a reaction between the silica complex and an organic silane coupling agent thereby creating a sol.

The titanium dioxide particles with the silica complex being absorbingly attached to exterior surfaces thereof prepared in step 1 and an organic silane coupling agent are dissolved in a tetrahydrofuran solvent and deionized water in predetermined proportions. In the preferred embodiment, the organic silane coupling agent is 3-(trimethoxysilyl)propyl methacrylate. A proportion by weight of the titanium dioxide particles coated with the silica complex to the organic silane coupling agent is in the approximate range from 3:4 to 6:1. A temperature of the reaction is preferably about 65 degree Celsius, and a time of the reaction is preferably about an hour.

The reaction process can be easily understood from the following reaction equation.

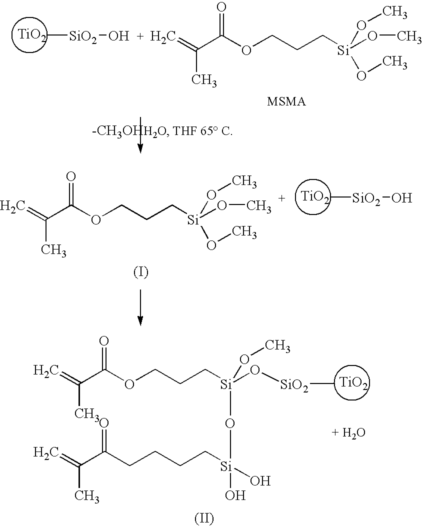

In the reaction, 3-(trimethoxysilyl)propyl methacrylate serves as an organic silane coupling agent. The hydrolytic condensation reaction of methoxysilyl group and silanol group of the silica complex being coated on exterior surfaces of titanium dioxide particles takes place in the tetrahydrofuran solvent and deionized water. As a result, the reaction creates the sol.

During the reaction, 3-(trimethoxysilyl)propyl methacrylate is at first hydrolyzed to produce an intermediate substance represented by structural formula (I). The intermediate substance of structural formula (I) includes silanol groups. The intermediate structural formula (I) then reacts with the silica complex. Some silanol groups react with the silica complex by dehydrated condensation to form siloxane bond on one side. At the same time, some silanol groups react with another molecule of 3-(trimethoxysilyl)propyl methacrylate by dehydrated condensation to produce a chemical bond on the other side. In the end, the sol with structural formula (II) is formed, which includes the silica complex unit and the organic silane coupling agent.

Step 3 is: polymerizing the sol with a polymeric resin thereby obtaining the paint composition.

A polymeric resin is mixed into the sol prepared in step 2 to polymerize it. In the preferred embodiment, the polymeric resin is polymethylmethacrylate. The polymethylmethacrylate is formed by polymerization of methylmethacrylat monomer in the reaction, and will form the polymeric resin unit of the polymer paint composition including. Preferably, an initiator can be introduced together with the polymeric resin. The initiator can be azoisobutyronitrile (AIBN). A time of the polymerization reaction is preferably 30 minutes, and a temperature is preferably 65 degree Celsius.

The substitute for the polymeric resin also may be selected from a group consisting of epoxy, polyurethane, and a copolymer of polyurethane and epoxy.

The process of the polymerization reaction can easily be understood from the following reaction equation. 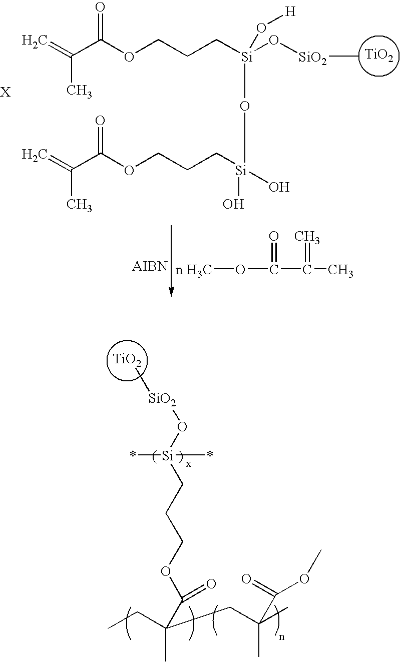
wherein, x is an integer in a range from 50 to 100, n is an integer in a range from 50 to 100.

Firstly, azoisobutyronitrile is dissolved in methylmethacrylat monomer and methyl ethyl ketone (MEK) to form a mixture. Secondly, the mixture is added to the sol prepared in step 2 to polymerize. A time of the polymerization reaction is preferably 30 minutes, and a temperature is preferably 65 degree Celsius.

In the preferred embodiment, the polymer binds with the inorganic substances such as the silica complex attached to exterior surfaces of titanium dioxide particles on one side and the organic functional group reacts with the organic substance such as polymethylmethacrylate on the other side. On one side of the polymer, it is binding with the silica complex attached to exterior surfaces of titanium dioxide particles via methoxysilyl group, and on the other side of the polymer, the alkene bond polymerizes with organic such as polymethylmethacrylate. As a result, the silica complex unit such as colloidal silica and the polymeric resin unit such as polymethylmethacrylate are tightly bound to each other.

Therefore, inorganic substances and organic substances bond together effectively through this method. The binding force will avoid titanium dioxide particles being eroded out of the surface of a coating using the present paint composition. As titanium dioxide particle sizes are in the nanometer range and they are coated with the silica complex such as colloidal silica, photocatalysis of titanium dioxide can be restrained effectively to prevent the destruction of the configuration of the organic resin.

A surface may be coated using a typical coating method such as spin coating or spray coating. Finally, the paint composition may be prepared for use as a coating with good transparency and hardness on the surface by heat curing.

While certain embodiments of the present invention have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

I claim:

1. A paint composition comprising:
a polymer containing a polymeric resin unit, a silica complex unit, an organic silane coupling agent interconnecting the polymeric resin unit and the silica complex unit, and
a plurality of titanium dioxide particles with the silica complex unit of the polymer being absorbingly attached to exterior surfaces thereof.

2. The paint composition as claimed in claim 1, wherein the polymeric resin unit is selected from a group consisting of polymethylmethacrylate, epoxy, polyurethane, and copolymer of polyurethane and epoxy.

3. The paint composition as claimed in claim 1, wherein the organic silane coupling agent is represented by a formula of 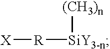
wherein n is an integer in a range from 0 to 2; X represents an organic functional group, Y represents a hydrolyzable group, and R represents an alkene group.

4. The paint composition as claimed in claim 3, wherein the organic silane coupling agent is 3-(trimethoxysilyl)propyl methacrylate.

5. The paint composition as claimed in claim 3, wherein the organic functional group is selected from a group consisting of vinyl, epoxy, amino, methacrylic, and mercapto.

6. The paint composition as claimed in claim 3, wherein the hydrolyzable group is an alkoxy group.

7. The paint composition as claimed in claim 1, wherein a particle size of the titanium dioxide is in a range from 200 nanometers to 300 nanometers.

8. A method for manufacturing a paint composition comprising the steps of:
preparing a plurality of titanium dioxide particles with a silica complex being absorbingly attached to exterior surfaces thereof;
conducting a reaction between the silica complex and an organic silane coupling agent thereby creating a sol; and
polymerizing the sol with a polymeric resin thereby obtaining the paint composition.

9. The method as claimed in claim 8, wherein the polymer resin is selected from a group consisting of polymethylmethacrylate, epoxy, polyurethane, and a copolymer of polyurethane and epoxy.

10. The method as claimed in claim 8, wherein the organic silane coupling agent is represented by formula 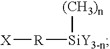
n is an integer in a range from 0 to 2; X represents an organic functional group, Y represents a hydrolyzable group, and R represents an alkene group.

11. The method as claimed in claim 10, wherein the organic silane coupling agent is 3-(trimethoxysilyl)propyl methacrylate.

12. The method as claimed in claim 10, wherein the organic functional group is selected from a group consisting of vinyl, epoxy, amino, methacrylic, and mercapto.

13. The method as claimed in claim 10, wherein the hydrolyzable group is an alkoxy group.

14. The method as claimed in claim 8, wherein the step of preparing the titanium dioxide particles with the silica complex being absorbingly attached to exterior surfaces thereof further comprises the steps of:
immersing a plurality of titanium dioxide particles in a solution containing tetraethyl orthosilicate;
removing an excessive solution of tetraethyl orthosilicate thereby obtaining the wet titanium dioxide particles with the tetraethyl orthosilicate being coated on exterior surfaces thereof;
drying the titanium dioxide particles in vacuum thereby forming the dry titanium dioxide particles coated with tetraethyl orthosilicate; and
conducting a catalyzed reaction between the tetraethyl orthosilicate and alcohol, thereby obtaining the titanium dioxide particles with the silica complex being absorbingly attached to exterior surfaces thereof.

15. The method as claimed in claim 14, wherein a particle size of the titanium dioxide is in a range from 200 nanometers to 300 nanometers.

16. The method as claimed in claim 14, wherein a total particle size of the titanium dioxide and respective silica complex is in a range from 200 nanometers to 500 nanometers.

17. The method as claimed in claim 9, wherein the sol is prepared by conducting a hydrolytic condensation reaction in a solution containing a tetrahydrofuran solvent and deionized water.

18. The method as claimed in claim 17, wherein a proportion by weight of titanium dioxide particles with the silica complex to the organic silane coupling agent is in the approximate range from 3:4 to 6:1.
